(19) United States
(12) Patent Application Publication
(10) Pub. No.: US 2008/0073611 A1
(43) Pub. Date: Mar. 27, 2008

(54) Method for control of a proportional magnet of an electromagnetic valve

(75) Inventors: Karlheinz Mayr, Bregenz (AT); Markus Moosmann, Ravensburg (DE); Maik Wiesner, Friedrichshafen (DE); Walter Kill, Friedrichshafen (DE)

Correspondence Address: DAVIS BUJOLD & Daniels, P.L.L.C., 112 PLEASANT STREET, CONCORD, NH, 03301, US

(73) Assignee: ZF Friedrichshafen AG, Friedrichshafen (DE)

(21) Appl. No.: 11/803,477

(22) Filed: May 15, 2007

(30) Foreign Application Priority Data
Jun. 8, 2006 (DE) 10 2006 026 630.7

(51) Int. Cl. F16K 31/06

(52) U.S. Cl. 251/129.01

(57) ABSTRACT

A method for control of a proportional magnet of an electromagnetic valve. Detecting valve seat bouncing by observing a control signal. Adjusting a control frequency or the alternate current amplitude to achieve the smallest hysteresis while preventing valve seat bouncing.

This application claims priority from German Application Serial No. 10 2006 026 630.7 filed Jun. 8, 2007.

### FIELD OF THE INVENTION

According to the preamble of claim 1, this invention relates to a method for control of a proportional magnet of an electromagnetic valve.

### BACKGROUND OF THE INVENTION

In the prior, art proportional magnets have been used in transmission controls, e.g., as drive mechanisms for pressure regulators to actuate shifting elements. In addition to control of characteristic curves of all operating states, it is also a goal to minimize hysteresis of the characteristic curves. This potential could then be used, for example, to better regulate properties of the valve or to compensate for variance in manufacturing tolerances, such as of the valve itself or of the sequence shift valve.

To reduce hystereses (a comparative value is the direct current hysteresis), it is already known to control the proportional magnets using alternative current amplitudes by modulating the control voltage, for example, by way of pulse-width modulation. An intermittent sawtooth-shaped current generates curves with slopes that are formed by e-functional curves.

A reduction of the frequency of the modulating signal results in high alternative current amplitudes of the energizing current and thus in an intensive stimulation of the magnet armature of the electromagnetic valve containing the proportional magnet, which advantageously leads to reduction of the hysteresis, since the amount of sliding friction increase (the amplitude of the movements of the magnet armature becomes greater as the cycle frequencies is smaller). But, if the frequency of the modulating signal cannot be reduced at will, since with amplitude of the mechanical deflection of the magnet armature, when combined with a proportional magnet having a hydraulic seat valve, sometimes bounce on mechanical the end stops of the system (the magnetic armature impinges upon the valve seat). To overcome this drawback, i.e., the so-called seat rebounding, the frequency of the modulation has to be increased as a countermeasure such that armature deflections are limited, which disadvantageously results in an increase of the hysteresis.

From DE 103 04 711 A1, a method for control of an electromagnetic valve is disclosed. Within the scope of the method, a cycle frequency and thus also a period of the pulse-width modulated control signal is changed according to the magnitude of operation of the electromagnetic valve. The nominal and/or the actual current through the coil of the electromagnetic valve can be used as operation parameters.

From DE 103 15 152 A1, another method for control of an electromagnetic valve is known where the cycle frequency and also a period of the pulse-width modulated control signal is changed, according to the engagement portion of the control signal.

The problem on which the invention is based is to outline a method for control of a proportional magnet of an electromagnetic valve, by the application of which the hysteresis is slightly detained and the danger of seat bouncing is prevented to a great extent.

### SUMMARY OF THE INVENTION

Accordingly, it is proposed to detect bouncing of the valve on the valve seat and then adjust the control frequency or the alternate current amplitude of the control current signal so as to achieve an optimal hysteresis. The slightest possible hysteresis is obtained when a “seat bouncing” is prevented.

According to a first a specially advantageous alternative of the inventive method, seat bouncing is detected by an armature displacement sensor integrated in the electromagnetic valve. Within the scope of another embodiment, seat bouncing is detected on the actual current curve, via the counter-induction reaction which is produced by seat bouncing.

The detection of seat bouncing is advantageously used in order to generate control-frequency dependent hysteresis from the pressure regulating element to the shifting element.

In detecting the seat bouncing, via the counter-induction reaction produced by seat bouncing in the actual current curve, the first derivative of the actual current curve is evaluated. The first derivative of the current curve, without seat bouncing, has no point of inflection here, with seat bouncing a point of inflection is generated in the first derivative whereby, according to the invention, seat bouncing is detected. Hysteresis is optimized by adjustment depending on the tendency of seat bouncing.

### BRIEF DESCRIPTION OF THE DRAWINGS

The invention will now be described, by way of example, with reference to the accompanying drawings in which:

FIG. 1 is a schematic view of a relevant part of the invention, namely an electromagnetic valve comprising one armature sensor according to the invention, and

FIG. 2 is a diagram illustrating the actual current curve and the curve of the first derivative, with and without seat bouncing, as a function of time at a modulating frequency of 250 Hz.

### DETAILED DESCRIPTION OF THE INVENTION

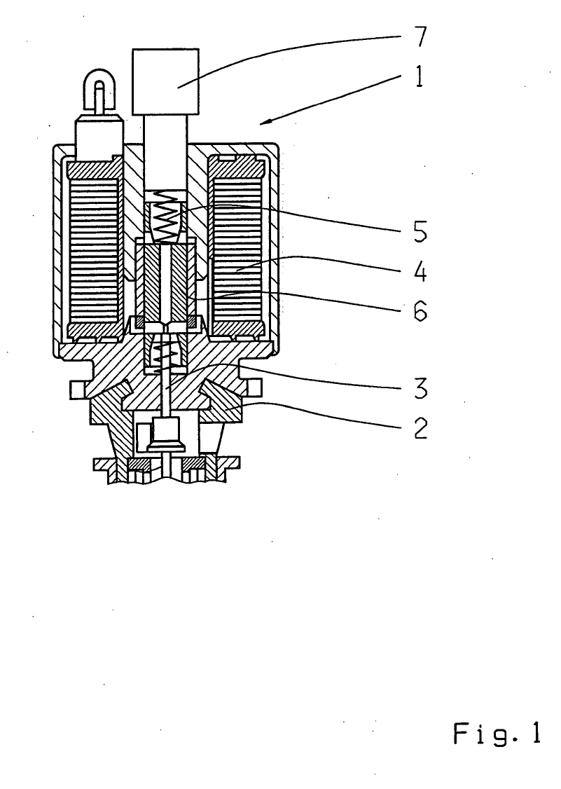

FIG. 1 shows an electromagnetic valve 1 with a housing 2 and a rod 3 of a magnet armature 6. A magnetic coil 4 and a pressure spring 5 for the magnet armature 6 are also shown. According to the invention, for detection of seat bouncing, an armature displacement sensor 7 is provided such that after detection, the control frequency or the alternate current amplitude of the control current signal is adjusted, to achieve an optimal hysteresis while preventing seat bouncing.

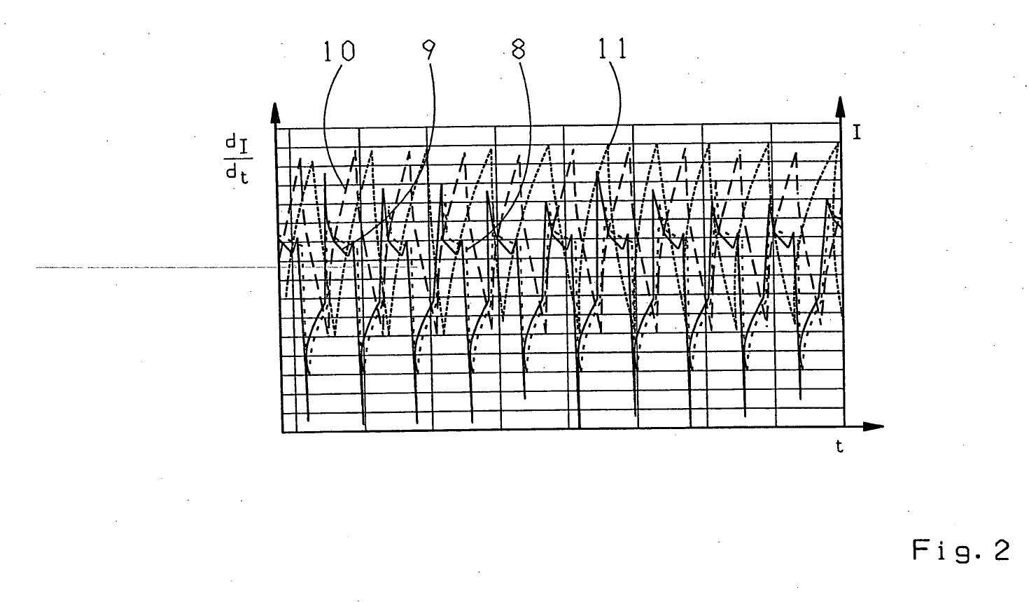

FIG. 2 is for the detection of the seat bouncing, via the counter-induction reaction of an actual current curve 10, 11 caused by the seat bouncing.

As can be seen from FIG. 2, a first derivative of a current curve without seat bouncing 8 has no point of inflection. With seat bouncing, a point of inflection is generated in a first derivative 9 to induce where, according to the invention, seat bouncing is detected, an optimal hysteresis is adjusted, in this case, depending on the seat bouncing tendency, via the control of frequency of the alternate current and the amplitude of the control signal.

Reference Numerals

1 electromagnetic valve
2 housing
3 armature rod
4 magnet coil
5 pressure spring
6 magnet armature
7 armature displacement sensor
8 derivative of the current curve without seat bouncing
9 derivative of the current curve with seat bouncing
10 current curve with seat bouncing
11 current curve without seat bouncing

1-4. (canceled)

5. A method of controlling a proportional magnet of an electromagnetic valve, the method comprising the steps of:
detecting seat bouncing of the valve; and
adjusting a frequency of an alternate current and an amplitude of a control current to prevent seat bouncing and minimize hysteresis.

6. The method of controlling the proportional magnet according to claim 5, further comprising the step of detecting the seat bouncing of the valve with an armature displacement sensor (7) integrated in the electromagnetic valve (1).

7. The method of controlling the proportional magnet according to claim 5, further comprising the step of detecting the seat bouncing of the valve via a counter-induction reaction produced by the seat bouncing on an actual current curve (10, 11).

8. The method of controlling the proportional magnet according to claim 7, further comprising the step of examining a first derivative of the actual current curve (8, 9) for a point of inflection with the point inflection indicating the seat bouncing.

9. A method of minimizing hysteresis during control of an electromagnetic valve by controlling a proportional magnet of the electromagnetic valve, the method comprising the steps of:
measuring a profile of an actual current flow through the electromagnetic valve;
calculating a profile of a first derivative of the actual current flow through the electromagnetic valve;
observing the profile of the first derivative of the actual current flow through the electromagnetic valve, for a point of inflection, presence of the point of inflection indicating valve seat bouncing; and
adjusting at least one of a frequency of an alternate current and an amplitude of a control current, upon the observation of valve seat bouncing, to minimize valve seat bouncing and hysteresis.
